(19) United States
(12) Patent Application Publication
(10) Pub. No.: US 2011/0215276 A1
(43) Pub. Date: Sep. 8, 2011

(54) Phosphorescent light-emitting material

(75) Inventors: Mohammad Khaja Nazeeruddin, Ecublens (CH); Etienne David Baranoff, Renens VD (CH); Michael Graetzel, Saint Sulpice (CH)

(73) Assignee: SOLVAY SA, Brussels (BE)

(21) Appl. No.: 13/128,391

(22) PCT Filed: Nov. 10, 2009
(86) PCT No.: PCT/EP2009/064932

§ 371 Date: May 9, 2011

(30) Foreign Application Priority Data
Nov. 12, 2008 (EP) 08168890.5

(51) Int. Cl. C09K 11/06; C07F 15/00

(52) U.S. Cl. 252/301.16; 546/4

(57) ABSTRACT

The present invention relates to light emitting materials including a novel Ir complex, where the Ir is provided with a primary ligand selected from phenyl pyridine ligands substituted with at least one Cl atom. Such light emitting materials have been found to have a significantly enhanced photoluminescence quantum yield over other Ir complexes with a phenyl pyridine ligand having no Cl atom, or even over those with a phenyl pyridine ligand having a halogen atom other than Cl, such as a Br or F atom, and as a result specifically improve the efficiency of a light emitting device. The present invention further relates to the use of such light emitting materials and an organic light emitting device including such light emitting materials.

### REFERENCE TO RELATED APPLICATION

This application claims priority to European patent application 08168890.5 filed on Nov. 12, 2008, incorporated herein by reference.

### TECHNICAL FIELD

The present invention relates to a light-emitting material, the use of such material, and a light-emitting device capable of converting electrical energy into light.

### BACKGROUND

Recently, various display devices have been under active study and development, particularly those based on electroluminescence from organic materials.

Electroluminescence (EL) is a non-thermal generation of light, resulting from the application of an electric field to a substrate, while photoluminescence is light emission from an active material due to optical absorption and relaxation by a radiative decay of excited state. In the case of EL, excitation is accomplished by a recombination of charge carriers of opposite signs (electrons and holes) injected into an organic semiconductor in the presence of an external circuit.

Many organic materials exhibit fluorescence (i.e., luminescence from a symmetry-allowed process) from singlet excitons. Since this process occurs between states of the same symmetry, it may be very efficient. On the contrary, if the symmetry of an exciton is different from the one of the ground state, then the radiative relaxation of the exciton is disallowed and luminescence will be slow and inefficient. Because the ground state is usually anti-symmetric, the decay from a triplet breaks the symmetry. The process is thus disallowed and the efficiency of EL is very low. Therefore, the energy contained in the triplet states is mostly wasted.

The luminescence from a symmetry-disallowed process is known as phosphorescence. Characteristically, phosphorescence may persist up to several seconds after excitation due to the low probability of the transition, in contrast to fluorescence which shows rapid decay.

The successful utilization of phosphorescent materials holds enormous promise for organic electroluminescent devices. For example, one advantage of utilizing phosphorescent materials is that all excitons (formed by combining holes and electrons in EL), which are, in part, triplet-based in phosphorescent devices, may participate in energy transfer and luminescence. This can be achieved either by phosphorescence emission itself or by using phosphorescent materials to improve the efficiency of the fluorescence process.

In each case, it is important that the light emitting material provides electroluminescence emission in a relatively narrow band centered near selected spectral regions, which correspond to one of the three primary colors, i.e., red, green, and blue. This is so that they may be used as a colored layer in an organic light emitting device (OLED).

As a means for improving the properties of light-emitting devices, there has been reported a light-emitting device utilizing the emission from an iridium complex having a phenylpyridine ligand.

Japanese Patent Publication No. 2003109758 A discloses an organic electroluminescent element of high brightness using a phosphorescent compound having a light color at the blue region for use in organic electroluminescence. For such an electroluminescent element, metal complexes having a biaryl ligand of a specific structure including carbon cycles or heterocycles with a torsion angle (dihedron) of the plane of its two aryl rings at not less than 9° and less than 90° is contained in a light emitting layer.

U.S. Patent Application Publication Nos. US 2006/099446 and US 2005/214576, assigned to Samsung SDI Co Ltd., disclose a cyclometalated transition metal complex emitting phosphorescence of high efficiency which can emit light at a wavelength range of 400 nm to 650 nm, and can also emit white light when used with a green light emitting material and a red light emitting material.

You et al, “Blue Electrophosphorescence from Iridium Complex Covalently Bonded to the Poly(9-dodecyl-3-vinylcarbazole): Suppressed Phase Segregation and Enhanced Energy Transfer,” Macromolecules, 39(1): 349-356 (2006) discloses iridium(III) bis[(4,6-difluorophenyl)-pyridinato-N,C^{2′}]picolinate (Flrpic) covalently bonded to the carbazole-based wide-band-gap polymer host (poly-(9-dodecyl-3-vinylcarbazole); CP0). EL devices employing CPₙ polymers as the emitting layer showed exclusive Flrpic emission due to the efficient energy transfer and subsequent exciton confinement in Flpic, resulting in a luminance as high as 1450 cd/m² with an emission efficiency of 2.23 cd/A.

However, the above light-emitting materials in the art do not exhibit sufficient luminescent efficiency. Further, they do not display pure colors, i.e., their emission bands are somewhat broad at the selected spectral regions. Thus, currently there are few efficient and long-lasting light emitters with good color coordinates that could be used in organic electroluminescent devices. Accordingly, there has been a desire to develop phosphorescent light-emitting materials that have highly efficient luminescence as well as a narrow spectral region.

### BRIEF DESCRIPTION OF THE DRAWINGS

FIG. 1 is a cross-sectional view of a display device containing the organic light emitting device of the present invention.

FIG. 2 shows the absorption and fluorescence spectra of the complexes of Formulae II, IX, and X.

### DESCRIPTION OF THE INVENTION

It is thus an object of the present invention to provide an Ir, where the Ir is provided with a primary ligand selected from phenyl pyridine ligands substituted with at least one Cl atom, as described below. The Ir complex has advantageously a quantum yield greater than 0.6, preferably greater than 0.7, even more preferably greater than 0.8, or even greater than 0.9

Another object of the present invention is a light emitting material comprising the above mentioned complex and to provide an organic light emitting device including the above light emitting material.

The Ir complex of the invention is generally non-ionic (or neutral). In most cases, the Ir complex of the invention is mononuclear. This means that the complex contains only one single Ir atom.

Very often, the Ir complex of the invention is provided with a primary phenyl pyridine ligand substituted with at least two halogen atoms, one of which is the Cl atom. In that case it is advantageous that the two halogen atoms X are positioned as in the formula (Ia):

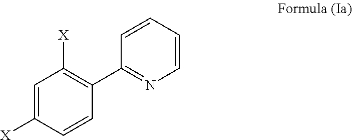

The term phenyl pyridine used herein is intented to denote 2-phenylpyridine.

In one embodiment, the present invention provides an Ir complex having a primary ligand of the following formula Ib:

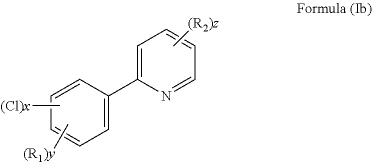

where:
R₁ and R₂ are the same or different at each occurrence and are —F; —Br; —NO₂; —CN; —CONR₄; —COOR₅; a straight-chain or branched or cyclic alkyl or alkoxy group or dialkylamino group having from 1 to 20 carbon atoms, where one or more non-adjacent —CH₂— groups may be replaced by —O—, —S—, —NR₃—, —COO—, or —CO— and where one or more hydrogen atoms may be replaced by halogen; or an aryl or heteroaryl or aryloxy group having from 4 to 14 carbon atoms which may be substituted by one or more non-aromatic radicals, where a plurality of R₁ and R₂, either on the same ring or on two different rings, may in turn together form a mono- or polycyclic ring, optionally aromatic, where R₃˜R₅ are the same or different at each occurrence and independently selected from the group consisting of —H, halogen, —NO₂, —CN, a straight or branched C₁₋₂₀ alkyl, a C₃₋₂₀ cyclic alkyl, a straight or branched C₁₋₂₀ alkoxy, a C₁₋₂₀ dialkylamino, a C₄₋₁₄ aryl, a C₄₋₁₄ aryloxy, and a C₄₋₁₄ heteroaryl which may be substituted by one or more non-aromatic radicals;
x is an integer from 1 to 5; and
y and z are the same or different at each occurrence and are an integer from 0 to 4 where x+y≦5.

In some embodiments of the present invention, the primary ligand is selected from the group consisting of

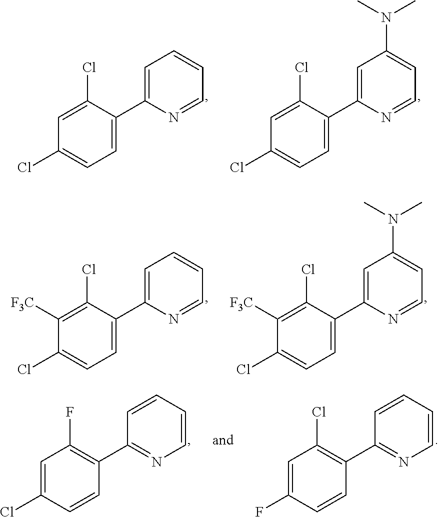

In other embodiments of the present invention, the Ir complex further includes at least one ancillary ligand independently selected from the group consisting of halogen, —CN, —SCN, —NCO, tetraalkylammonium salts,

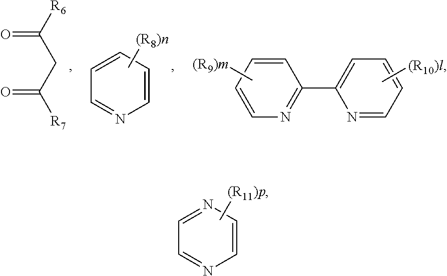

and PR₁₂R₁₃R₁₄, where R₆˜R₁₄ are the same or different at each occurrence and are —F; —Cl; —Br; —NO₂; —CN; —COOR₁₅; a vinyl group; a straight-chain or branched or cyclic alkyl or alkoxy group or dialkylamino group having from 1 to 20 carbon atoms, where each of the one or more nonadjacent —CH₂— groups may be replaced by —O—, —S—, —NR₁₆—, —CONR₁₇—, or —COOR₁₈, and where each of the one or more hydrogen atoms may be replaced by halogen; or an aryl or heteroaryl or aryloxy group having from 4 to 14 carbon atoms which may be substituted by one or more non aromatic radicals, where a plurality of R₆˜R₁₄, either on the same ring or on two different rings, may in turn together form a mono- or polycyclic ring, optionally aromatic, where R₁₅˜R₁₈ are the same or different at each occurrence and independently selected from the group consisting of —H, halogen, —NO₂, —CN, a straight or branched C₁₋₂₀ alkyl, a C₃₋₂₀ cyclic alkyl, a straight or branched C₁₋₂₀ alkoxy, a C₁₋₂₀ dialkylamino, a C₄₋₁₄ aryl, a C₄₋₁₄ aryloxy, and a C₄₋₁₄ heteroaryl which may be substituted by one or more non aromatic radicals, where m, l, and p are the same or different at each occurrence and are an integer from 0 to 4, and n is an integer from 0 to 5.

In some embodiments of the present invention, the ancillary ligand is selected from the group consisting of —F, —Cl, —Br, tetrabutylammonium hydroxide (TBAOH), cyanide,

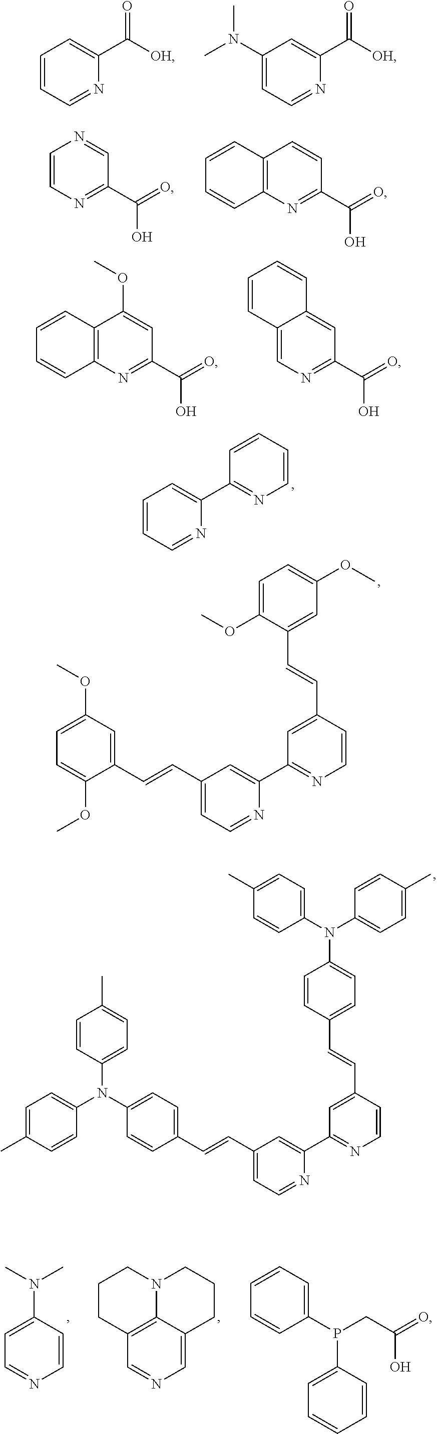

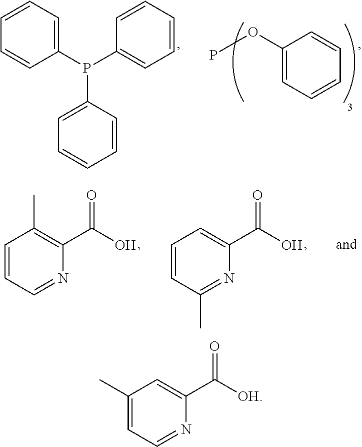

In other embodiments of the present invention, the Ir complex has a formula selected from the group consisting of:

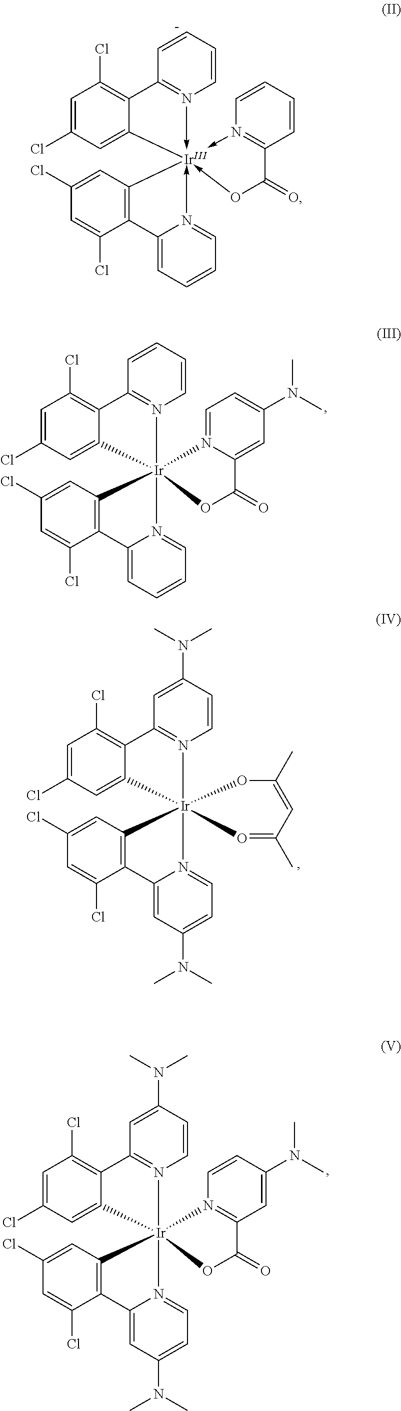

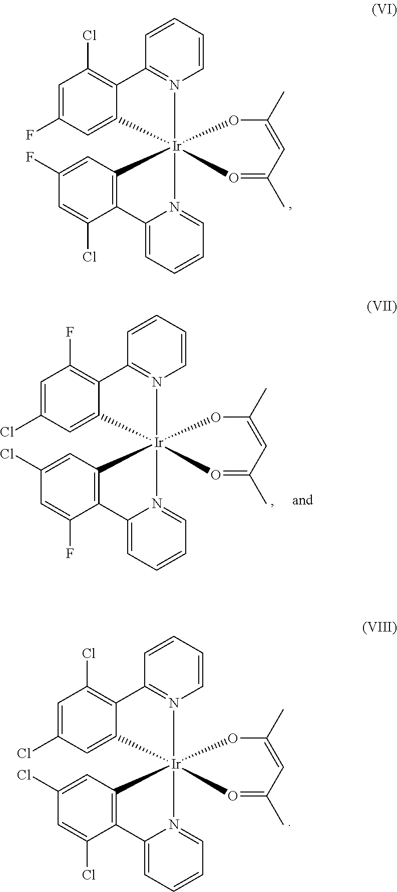

Surprisingly, it has been found that, when an Ir complex has a phenyl pyridine ligand (H—ĈN) substituted with at least one Cl atom, the photoluminescence quantum yield (PQY) of the emitting material for specifically improving the efficiency of a device is significantly enhanced over other Ir complexes with a phenyl pyridine ligand having no Cl atom, or even over those with a phenyl pyridine ligand having a halogen atom other than Cl, such as a Br or F atom. Especially compound II gives good results in that regard.

Generally, according to an embodiment of the present invention, the complex according to Formulae (II) to (VIII) can be prepared by the following reaction scheme:

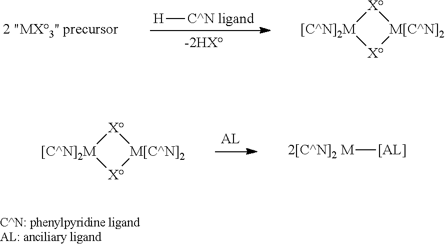

As shown in the above reaction scheme, the Ir complex according to this embodiment of the present invention can be prepared by reacting a dimer) ([ĈN]₂Ir(μ-X°)₂Ir[ĈN]₂) comprising two Ir atoms, two phenyl pyridine ligands(ĈN) substituted with at least one Cl atom, and two halogen ligands (X°) in the presence of a base compound with a compound (AL) from which the ancillary ligand is derived. The phenyl pyridine ligands and ancillary ligands are commercially available or can be easily synthesized by using well-known organic synthetic methods.

In particular, phenyl pyridine ligands can be prepared with good to excellent yields by Suzuki coupling the substituted pyridine compound with corresponding arylboronic acids, preferably in the presence of a base compound like an alkali metallic base such as potassium bicarbonate, as described in Lohse et al., “The Palladium Catalyzed Suzuki Coupling of 2- and 4-Chloropyridines,” Syn. Lett., 1:15-18 (1999) and U.S. Pat. No. 6,670,645 assigned to Dupont de Nemours. In that embodiment, at least one of the arylboronic acids, such as phenylboronic acid, and a halogenated pyridine, such as bromopyridine, is substituted with at least one Cl atom to obtain a phenylpyridine ligand (H—ĈN) substituted with at least one Cl atom.

Trihalogenated iridium (III) compounds, such as IrCl₃.H₂O, hexahalogenated iridium (III) compounds, such as M°₃IrX°₆, where X° is a halogen (e.g., Cl) and M° is an alkaline metal (e.g., K), and hexahalogenated iridium compounds such as M°₂IrX°₆, where X° is a halogen (e.g., Cl) and M° is an alkaline metal (e.g., K)) (“Ir halogenated precursors”) can be used as starting materials to synthesize the Ir complexes of the present invention.

[ĈN]₂Ir(μ-X°)₂Ir[ĈN]₂ complexes, where X° is a halogen (e.g., Cl), can be prepared from the Ir halogenated precursors and the appropriate orthometalated ligand by using procedures already described in, for example, Sprouse et al., J. Am. Chem. Soc., 106:6647-6653 (1984); Thompson et al., Inorg. Chem., 40(7):1704 (2001); Thompson et al., J. Am. Chem. Soc., 123(18): 4304-4312 (2001).

In some embodiments, the reaction is carried out by using an excess of the neutral form of the orthometalated ligand (H—ĈN) and high-boiling temperature solvents. The term “high-boiling temperature solvent” is intended to denote a solvent having a boiling point of at least 80° C., at least 85° C., or at least 90° C. For instance, suitable solvents are methoxyethanol, ethoxyethanol, glycerol, dimethylformamide (DMF), N-methylpyrrolidone (NMP), dimethylsulfoxide (DMSO), and the like, where the solvents can be used as is or in admixture with water.

Optionally, the reaction can be carried out in the presence of a suitable Brønsted base, such as metal carbonates (e.g., potassium carbonate (K₂CO₃)), metal hydrides (e.g., sodium hydride (NaH)), metal ethoxide or metal methoxide (e.g., NaOCH₃ and NaOC₂H₅), alkylammonium hydroxides (e.g., tetramethylammonium hydroxide), or imidazolium hydroxides.

A nucleophilic substitution at the metal atom with a suitable ligand (AL),), in order to form corresponding [ĈN]₂Ir[AL], may be carried out in the presence of a base compound by more or less contacting a stoichiometric amount of the ancillary ligand AL with a bridged intermediate in a suitable solvent. In some embodiments, the compound from which the ancillary ligand (AL) is derived is selected from the group consisting of picolinic acid, quinoline carboxylic acid, and their derivatives. Polar aprotic solvents, e.g., methylene dichloride (CH₂Cl₂), may generally be used for this reaction.

The present invention is also directed to the use of a light emitting material as described above in the emitting layer of an organic light emitting device (OLED).

Furthermore, the present invention relates to using the light emitting material including the multinuclear complexes, as described above, as a dopant in a host layer, under conditions effective to function as an emissive layer in an organic light emitting device.

If the light emitting material is used as a dopant in a host layer, it is generally used in an amount of at least 1% wt, at least 3% wt, or at least 5% wt with respect to the total weight of the host and the dopant, and generally used in an amount of at most 25% wt, at most 20% wt, or at most 15% wt.

The present invention also relates to an OLED including an emissive layer. The emissive layer includes the light emitting material, as described above, optionally with a host material (where the light emitting material is specifically present as a dopant). The host material is notably adapted to luminesce when a voltage is applied across the device structure.

An OLED generally comprises:

a glass substrate;
an anode, which is a generally transparent anode such as an indium-tin oxide (ITO) anode;
a hole transporting layer (HTL);
an emissive layer (EML);
an electron transporting layer (ETL); and
a cathode, which is generally a metallic cathode such as an Al layer.

As for a hole conducting emissive layer, one may have an exciton blocking layer, notably a hole blocking layer (HBL) between the emissive layer and the electron transporting layer. As for an electron conducting emissive layer, one may have an exciton blocking layer, notably an electron blocking layer (EBL) between the emissive layer and the hole transporting layer. The emissive layer may be equal to the hole transporting layer (in which case the exciton blocking layer is near or at the anode) or to the electron transporting layer (in which case the exciton blocking layer is near or at the cathode).

The emissive layer may be formed with a host material in which the above-described light emitting material resides as a guest or the emissive layer may consist essentially of the light emitting material. In the former case, the host material may be a hole-transporting material selected from the group of substituted tri-aryl amines. Specifically, the emissive layer is formed with a host material in which the light emitting material resides as a guest. The host material may be an electron-transporting material selected from the group consisting of metal quinoxolates (e.g., aluminium quinolate (Alq₃), lithium quinolate (Liq)), oxadiazoles, and triazoles. An example of a host material is 4,4′-N,N′-dicarbazole-biphenyl [“CBP”], which has the following formula:

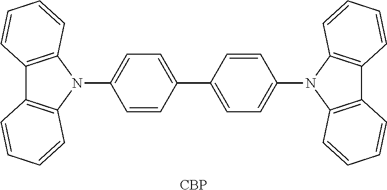

Optionally, the emissive layer may also contain a polarization molecule, which is present as a dopant in the host material and having a dipole moment, that generally affects the wavelength of light emitted when the light emitting material used as a dopant luminesces.

A layer formed of an electron transporting material is advantageously used to transport electrons into the emissive layer comprising the light emitting material and the (optional) host material. The electron transporting material may be an electron-transporting matrix selected from the group consisting of metal quinoxolates (e.g., Alq₃, Liq), oxadiazoles and triazoles. An example of an electron transporting material is tris-(8-hydroxyquinoline)aluminium of formula [“Alq₃”]:

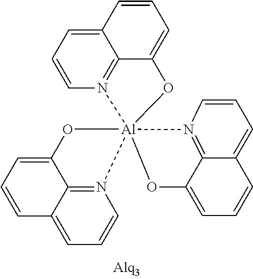

A layer formed of a hole transporting material is advantageously used to transport holes into the emissive layer comprising the above-described light emitting material and the (optional) host material. An example of a hole transporting material is 4,4′-bis[N-(1-naphthyl)-N-phenylamino]biphenyl [“α-NPD”].

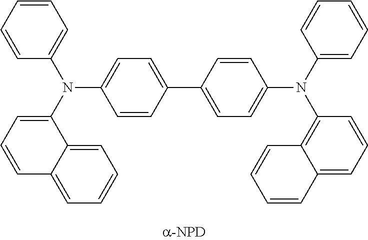

An exciton blocking layer (“barrier layer”) can be used to confine excitons within the luminescent layer (“luminescent zone”). As for a hole-transporting host, the blocking layer may be placed between the emissive layer and the electron transport layer. An example of a material, which is used for such a barrier layer, is 2,9-dimethyl-4,7-diphenyl-1,10-phenanthroline (also called bathocuproine or “BCP”) having the following formula:

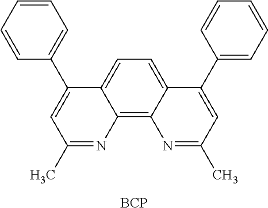

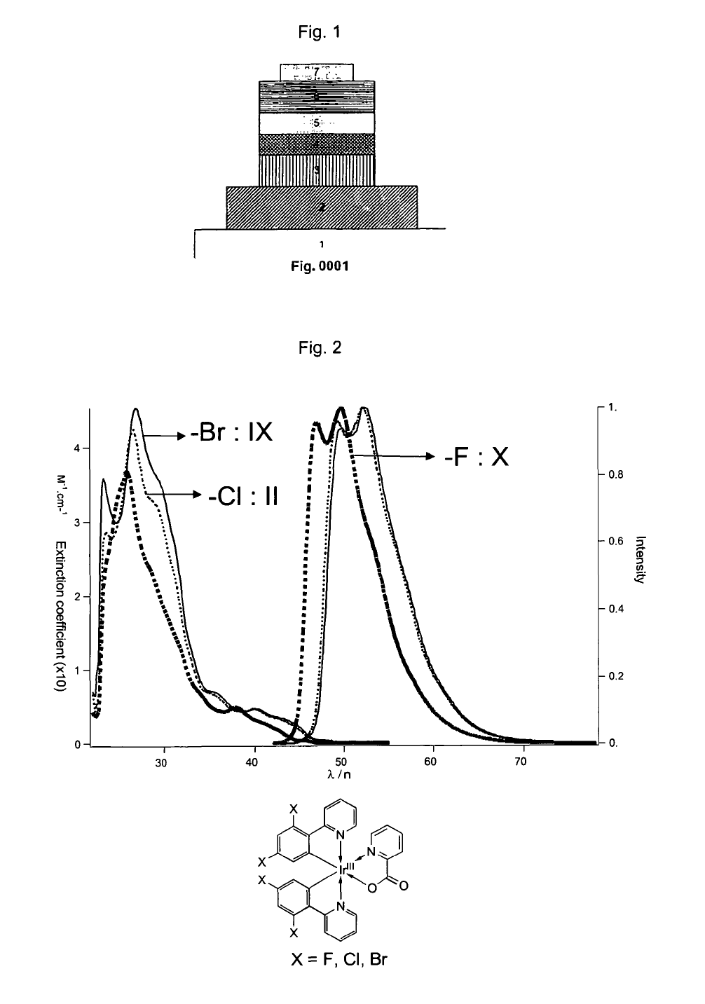

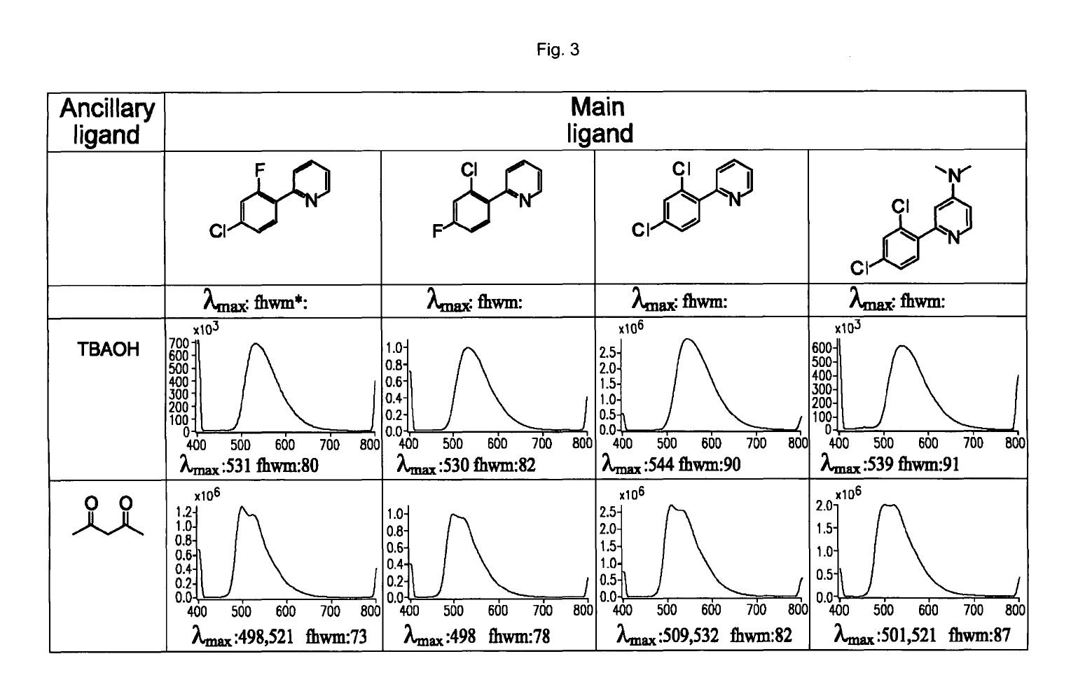

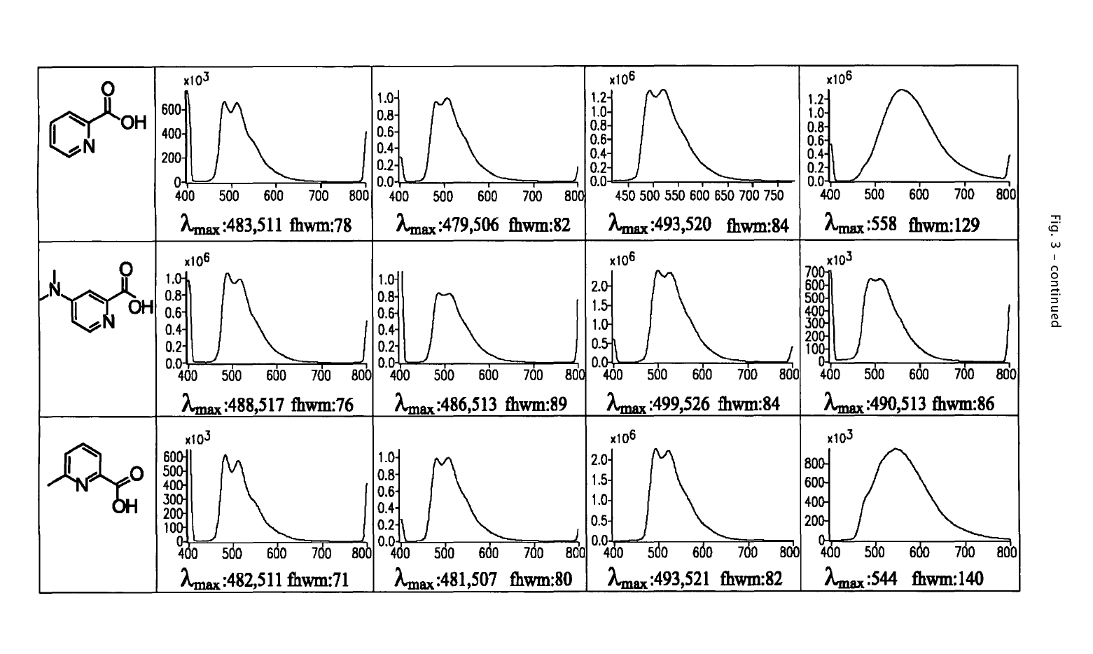

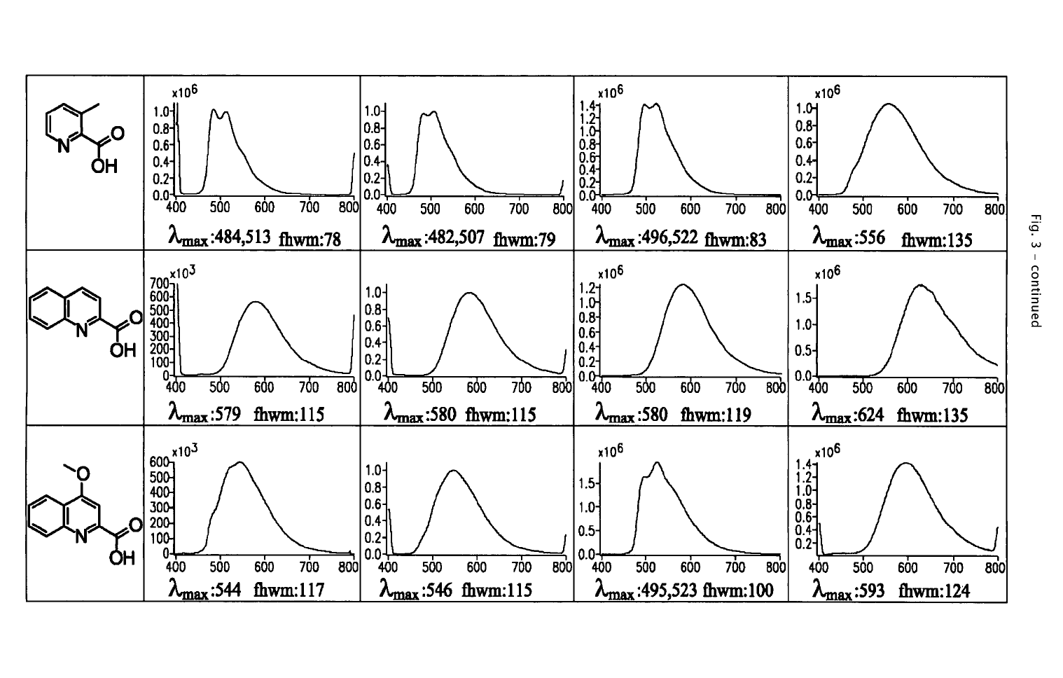

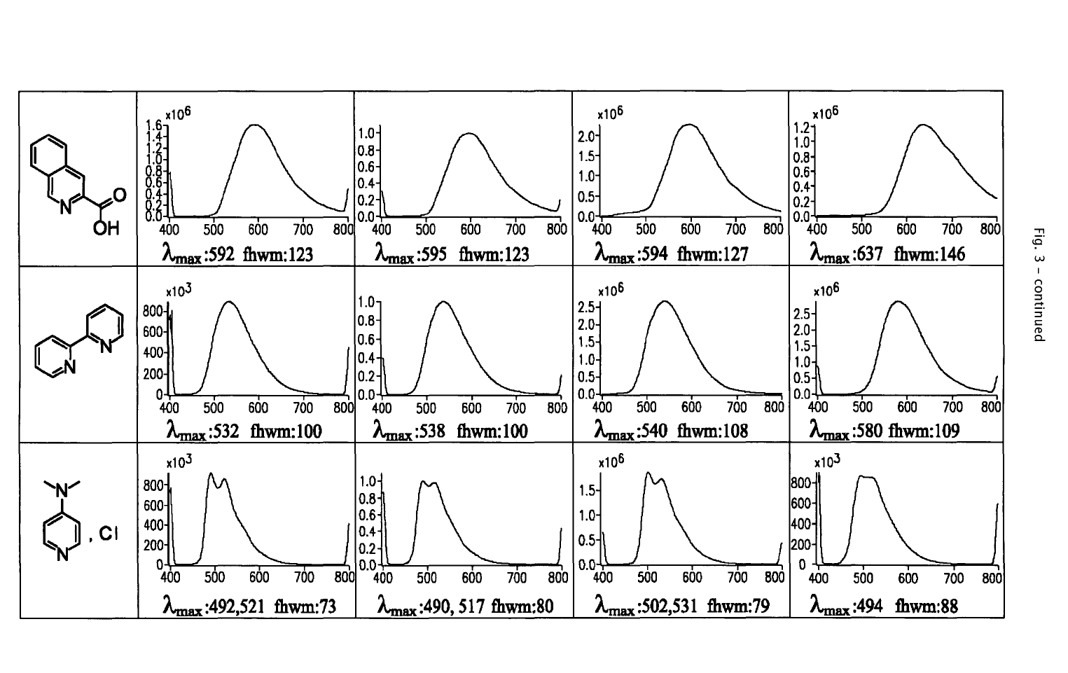

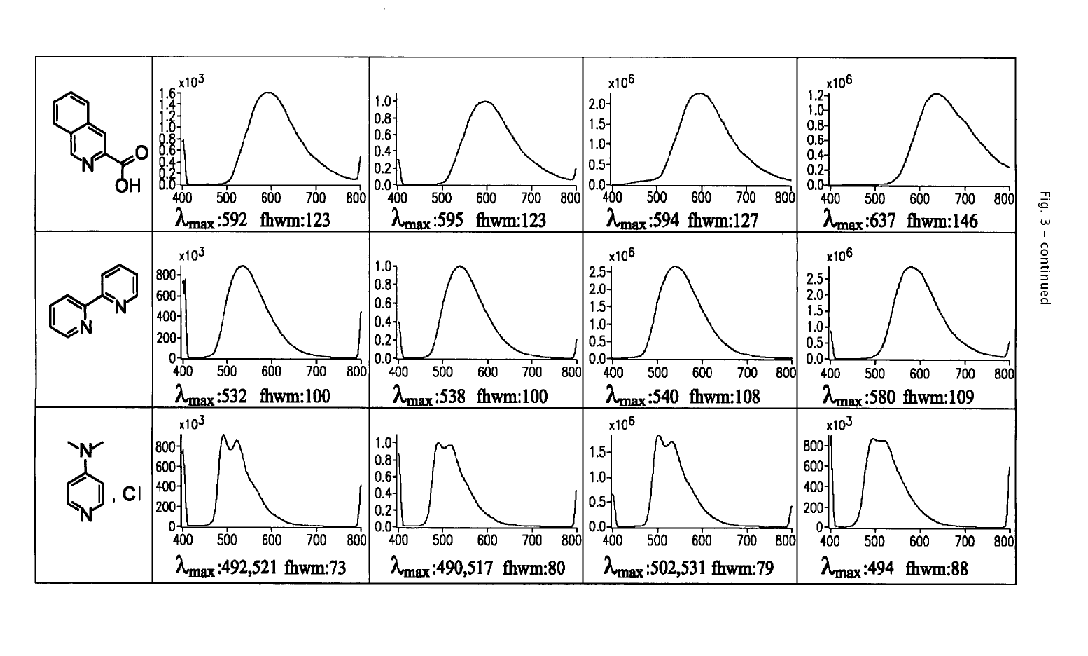

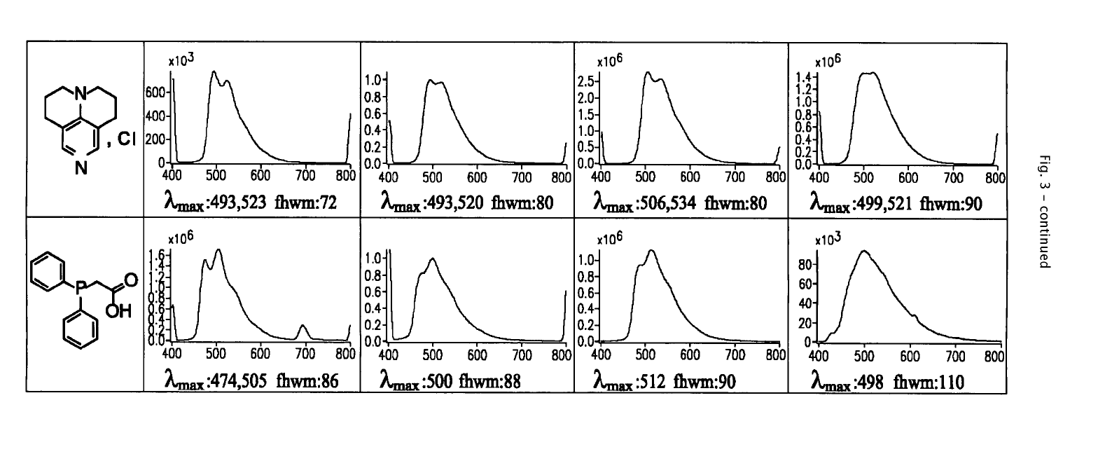

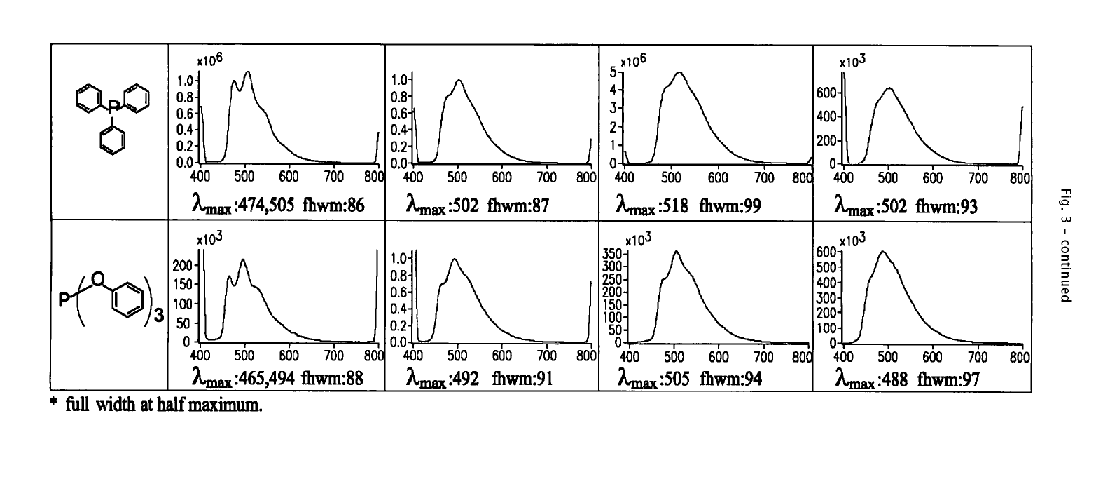

Specifically, the OLED may have a multilayer structure, as depicted in FIG. 1, wherein: 1 is a glass substrate; 2 is an ITO layer; 3 is a HTL layer comprising α-NPD; 4 is an EML comprising CBP as a host material and the light emitting material as a dopant in an amount of about 8% wt with respect to the total weight of the host and dopant; 5 is a HBL comprising BCP; 6 is an ETL comprising Alq₃; and 7 is an Al layer cathode.

Another aspect of the present invention relates to a display device including the above OLED.

### EXAMPLES

Hereinafter, the present invention will be explained in detail with reference to examples and comparative examples. These examples, however, should not in any sense be interpreted as limiting the scope of the present invention. Further, units are expressed by weight unless otherwise described.

### Example 1

### Synthesis of Formula II Compound

### Synthesis of 2-(2,4-dichlorophenyl)pyridine

A mixture of 2-bromopyridine (0.95 g, 6.0 mmol), 2,4-dichlorophenyl boronic acid (0.95 g, 7.2 mmol), and K₂CO₃ (3 g, 22.0 mmol) in toluene (30 mL) and water (5 mL) was degassed with Ar for 15 minutes. Pd(PPh₃)₄ (400 mg, 0.33 mmol) was added and the resulting mixture was heated to 100° C. for 15 h under Ar. After being cooled to room temperature, the aqueous phase was separated and extracted with EtOAc (3×100 mL). The combined organic fractions were washed with brine, dried over MgSO₄, filtered and evaporated. The crude compound was purified by column chromatography (SiO₂, CHCl₃/hexane, 50/50 then CHCl₃) to afford 1.10 g (68%) of the titled compound as a white solid. ¹H-NMR (δH/ppm in CDCl₃): 8.72 (d, J=6.0 Hz, 1H), 7.79 (t, J=6.5 Hz, 1H), 7.65 (d, J=7.2 Hz, 1H), 7.58 (d, J=6.1 Hz, 1H), 7.50 (s, 1H), 7.35 (d, J=7.1 Hz, 1H), 7.30 (t, J=7.2 Hz, 1H).

### Synthesis of the Formula II Compound

2-(2,4-dichlorophenyl)pyridine was reacted with IrCl₃ by using procedures described in the above-mentioned literature to provide the corresponding dimer, which was subsequently reacted with picolinic acid in refluxing dichloromethane with tetrabutyl ammonium hydroxide to obtain the compound of Formula II.

### Comparative Example 1

### Synthesis of Phenylpyridine-based Ligands having Br and F

The compounds represented by the following formulae were prepared as in Example 1 above, except that 2-(2,4-dibromophenyl)pyridine or 2-(2,4-difluorophenyl)pyridine was used instead of 2-(2,4-dichlorophenyl)pyridine. 2-(2,4-difluorophenyl)pyridine was synthesized as its chlorinated homologue and the synthesis of the 2-(2,4-dibromophenyl)pyridine was performed as follows:

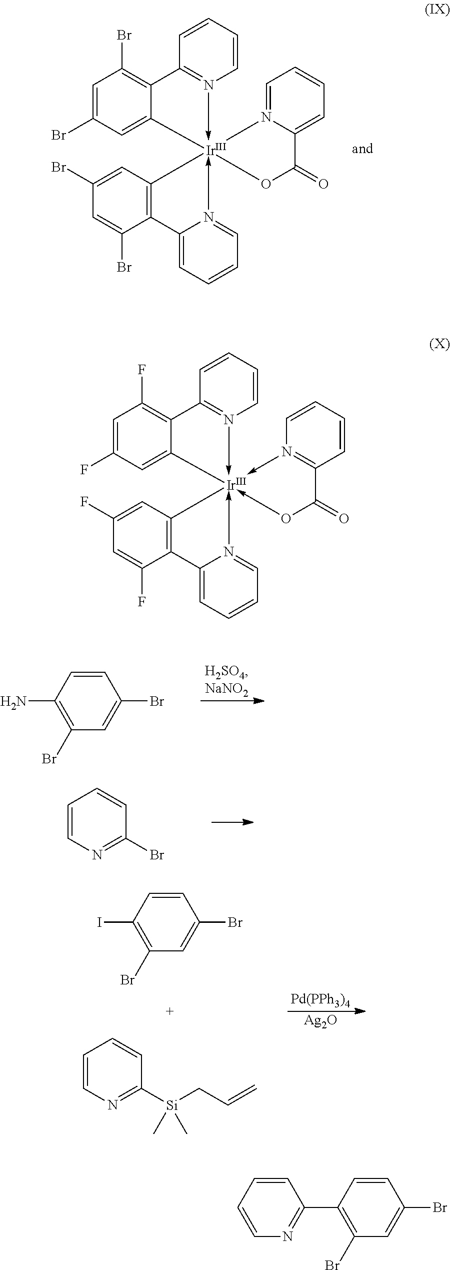

2,4-dibromoiodobenzene: To a mixture of the 2,4-dibromoaniline (5.02 g, 20 mmol), 45 mL of water, and 12 mL of concentrated sulfuic acid cooled to less than 10° C. in an ice bath was added a solution of 1.38 g (20 mmol) of sodium nitrite in 6 mL of water while maintaining the temperature at less than 10° C. The mixture was stirred for 30 min. The cooled solution was poured into a solution of 4.16 g (25 mmol) of potassium iodide in 20 mL of water. After the addition was complete, the water was heated to 60° C. over night. The black solution was cooled and chloroform was added. The organic layer was separated and washed with 10% sodium hydroxide, 1M sodium thiosulfate, 10% hydrochloric acid, water and saturated sodium chloride. The organic layer was dried over magnesium sulfate. The solvent was removed under reduced pressure to give the crude compounds. The crude compound was purified by column chromatography (SiO₂, CHCl₃/Hexane, 20/80) to afford 5.76 g (80%) of the titled compound as an orange solid.

(2-Pyridil)allyldimethylsilanes: To a solution of 2-bromopyridine (4.74 g, 30.0 mmol) in Et₂O (30 mL) was added dropwise a solution of n-butyllithium (21 ml, 1.60 M in hexane) at −78° C. under argon. The mixture was stirred at −78° C. for additional 1 h. The resultant solution of 2-pyridyllithium was added to a solution of allylchlorodimethylsilane (4.04 g, 30.0 mmol) in Et₂O (10 mL) at −78° C. After stirring at −78° C. for additional 1 h, water (10 mL) was added to the mixture at 0 C. The aqueous phase was extracted with EtOAc and the combined organic phase was dried over Na₂SO₄. Removal of the solvent under reduced pressure and subsequent flush silica gel chromatography (hexane/EtOAc=50/50 as eluent) afforded 2-(Allyldimethylsilyl)pyridine as pale yellow oil (2.89 g, 54%)

¹H-NMR (δH/ppm in CD₃Cl): 8.67 (dd, J=2.0 and 1.2 Hz, 1H), 8.58 (dd, J=2.0 and 4.8 Hz, 1H), 7.77 (dt, J=2.0 and 7.6 Hz, 1H), 7.26 (ddd, J=0.8, 4.8 and 7.2 Hz, 1H), 5.80 (m, 1H), 4.89 (m, 1H), 4.86 (m, 1H), 1.77 (dt, J=1.2 and 8.0 Hz, 2H), 0.32 (s, 6H).

2-(2,4-bromophenyl)pyridine: A mixture of 2-(Allyldimethylsilyl)pyridine (1.77 g, 10.0 mmol), 2,4-dibromoiodobenzen (4.70 g, 13.0 mmol), Ag₂O (3.47 g, 15.0 mmol), and Pd(PPh₃)₄ (635 mg, 0.55 mmol) in dry THF (50.0 mL) was stirred at 60° C. for 10 h under Ar. After cooling the reaction mixture to room temperature, the mixture was filtered with short silica gel pad. The crude mixture was chromatographed on silica gel (hexane/EtOAc=50/50 as eluent) to afford 2-(2,4-bromophenyl)pyridine (2.08 g, 66%) as white solid.

¹H-NMR ((δH/ppm in CD₃Cl): 8.72 (dt, J=2.0 and 7.0 Hz, 1H), 7.86 (d, J=5.5 Hz, 1H), 7.77 (td, J=2.0 and 7.6 Hz, 1H), 7.60 (dt, J=1.5 and 7.2 Hz, 1H), 7.55 (dd, J=2.2 and 7.0 Hz, 1H), 7.43 (d, J=7.2 Hz, 1H), 7.32 (ddd, J=1.2, 3.5 and 7.0 Hz, 1H).

### Example 2

### Luminescent Properties

The emission maxima of the compounds of Formulae II and IX were at 493, and 496 nm, respectively, which were slightly shifted to the red, compared to the Ir(2-(2,4-difluoro-phenyl)-pyridine)₂(picolinate) of 470 nm. The emission data revealed that the emission was shifted to the opposite of what was expected from Hammett's parameters. However, surprisingly the quantum yield of compound II were significantly higher than those of compound IX and Ir(2-(2,4-difluoro-phenyl)-pyridine)₂(picolinate) (see Table 1). In addition, the complexes of Formula II and IX exhibited narrow luminescence bandwidths at ˜85 nm at half of its intensity, making Formula II a highly interesting phosphor for OLED applications. Even though there is not a clear interpretation for such improved efficiency, it may be that the Br atom being too heavy may have lead to the quenching of the luminescence and a very short lifetime.

TABLE 1

| Quantum | | | |
|---|---|---|---|
| Yields | Complex X | Complex II | Complex IX |
| Φ | 0.5-0.6* | 0.95 | 0.09 |

*indicated in U.S. Patent Application Publication No. US 2005/0214576.

In addition to the complexes of Formula II and IX, representative Ir complexes having a primary ligand selected from phenyl pyridine ligands substituted with at least one Cl atom were prepared and their emissive properties were obtained (see FIG. 3 for results in CH₂Cl₂ solution).

It will be apparent to those skilled in the art that various modifications and variations can be made to the present invention without departing from the spirit and scope of the invention. Thus, it is intended that the present disclosure covers the modifications and variations of this invention, provided they come within the scope of the appended claims and their equivalents.

1. An Ir complex wherein said Ir is provided with a primary ligand selected from phenyl pyridine ligands substituted with at least one Cl atom.

2. The Ir complex according to any of claim 1, wherein said complex is non-ionic.

3. The Ir complex according to claim 1, wherein said complex is mononuclear.

4. The Ir complex according to claim 1, wherein the phenyl pyridine ligand is substituted with at least two halogen atoms, one of which is the Cl atom.

5. The Ir complex according to claim 1 wherein the two halogen atoms X are positioned as in the formula:

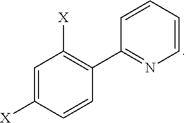

6. The Ir complex according to claim 1, wherein the primary ligand has the following formula: 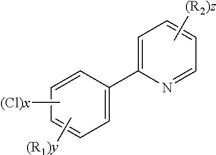
wherein
R₁ and R₂ are the same or different at each occurrence and representative of —F; —Br; —NO₂; —CN; —CONR₄; —COOR₅; a straight-chain or branched or cyclic alkyl or alkoxy group or dialkylamino group having from 1 to 20 carbon atoms, wherein one or more nonadjacent —CH₂— groups may be replaced by —O—, —S—, —NR₃—, —COO—, or —CO—, and wherein one or more hydrogen atoms may be replaced by halogen; or an aryl or heteroaryl or aryloxy group having from 4 to 14 carbon atoms which may be substituted by one or more non aromatic radicals, wherein a plurality of R₁ and R₂, either on the same ring or on two different rings, may in turn together form a mono- or polycyclic ring, optionally aromatic, wherein R₃˜R₅ are the same or different at each occurrence and independently selected from the group consisting of —H, halogen, —NO₂, —CN, a straight or branched C₁₋₂₀ alkyl, a C₃₋₂₀ cyclic alkyl, a straight or branched C₁₋₂₀ alkoxy, a C₁₋₂₀ dialkylamino, a C₄₋₁₄ aryl, a C₄₋₁₄ aryloxy, and a C₄₋₁₄ heteroaryl which may be substituted by one or more non aromatic radicals;
x is an integer from 1 to 5; and
y and z are the same or different at each occurrence and are an integer from 0 to 4 wherein x+y≦5.

7. The Ir complex according to claim 6, wherein the primary ligand is selected from the group consisting of

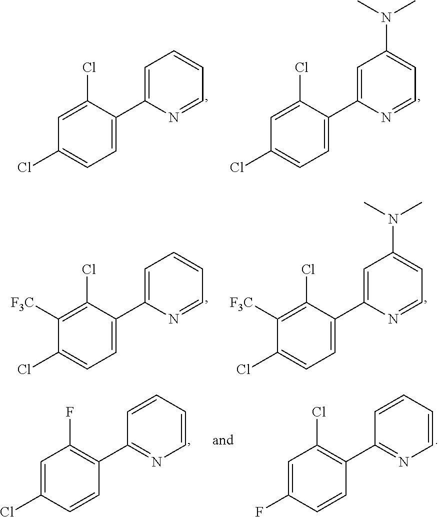

8. The Ir complex according to claim 1, wherein said Ir complex further comprises at least one ancillary ligand independently selected from the group consisting of halogen, —CN, —SCN, —NCO, tetraalkylammonium salts, 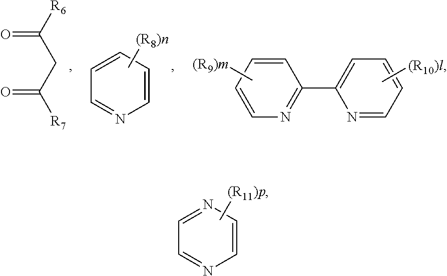
and PR₁₂R₁₃R₁₄, wherein R₆˜R₁₄ are the same or different at each occurrence and are —F; —Cl; —Br; —NO₂; —CN; —COOR₁₅; a vinyl group; a straight-chain or branched or cyclic alkyl or alkoxy group or dialkylamino group having from 1 to 20 carbon atoms, each of which one or more nonadjacent —CH₂— groups may be replaced by —O—, —S—, —NR₁₆—, —CONR₁₇—, or —COOR₁₈, and wherein each of which one or more hydrogen atoms may be replaced by halogen; or an aryl or heteroaryl or aryloxy group having from 4 to 14 carbon atoms which may be substituted by one or more non aromatic radicals, wherein a plurality of R₆˜R₁₄, either on the same ring or on two different rings, may in turn together form a mono- or polycyclic ring, optionally aromatic, R₁₅˜R₁₈ are the same or different at each occurrence and independently selected from the group consisting of —H, halogen, —NO₂, —CN, a straight or branched C₁₋₂₀ alkyl, a C₃₋₂₀ cyclic alkyl, a straight or branched C₁₋₂₀ alkoxy, a C₁₋₂₀ dialkylamino, a C₄₋₁₄ aryl, a C₄₋₁₄ aryloxy, and a C₄₋₁₄heteroaryl which may be substituted by one or more non aromatic radicals;
m, l, and p are the same or different at each occurrence and are an integer from 0 to 4; and
n is an integer from 0 to 5.

9. The Ir complex according to claim 8, wherein the ancillary ligand is selected from the group consisting of —F, —Cl, —Br, hydroxide (TBAOH), cyanide,

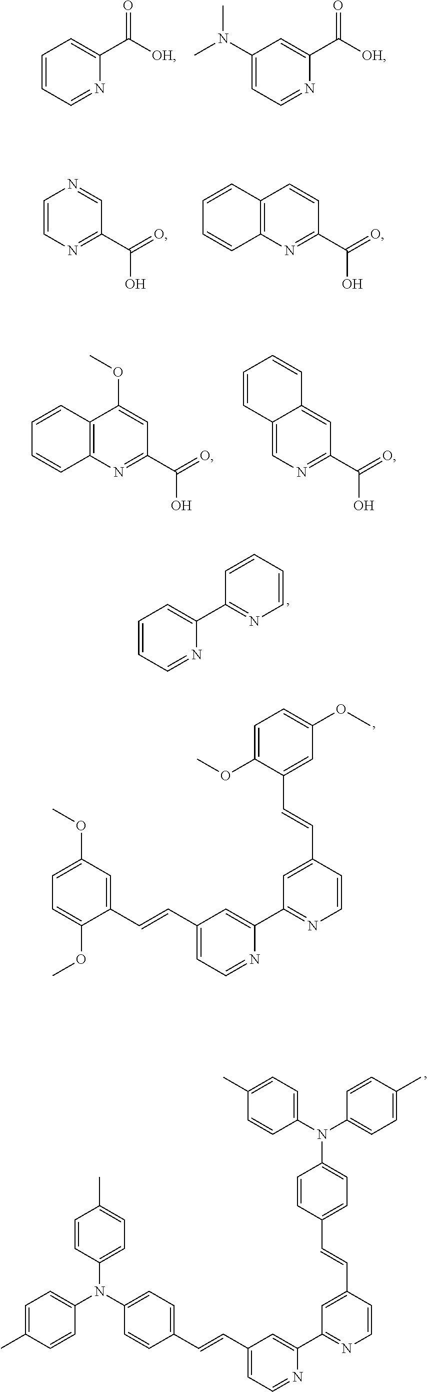

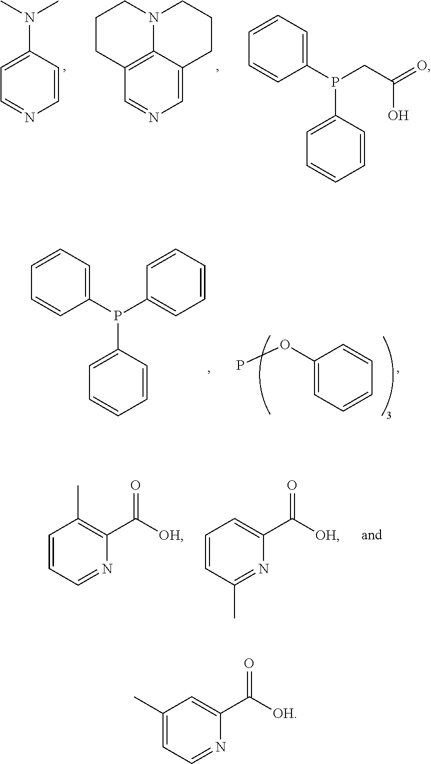

10. The Ir complex according to claim 1, wherein said Ir complex has a formula selected from the group consisting of:

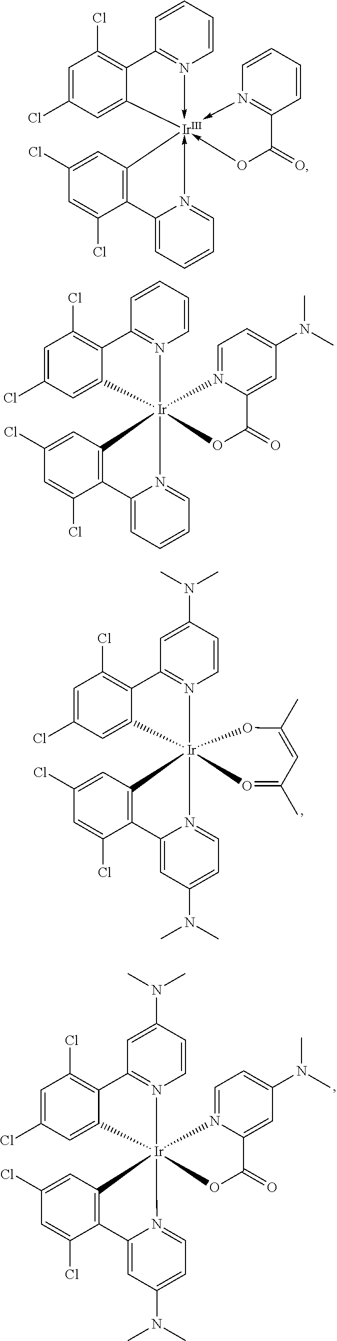

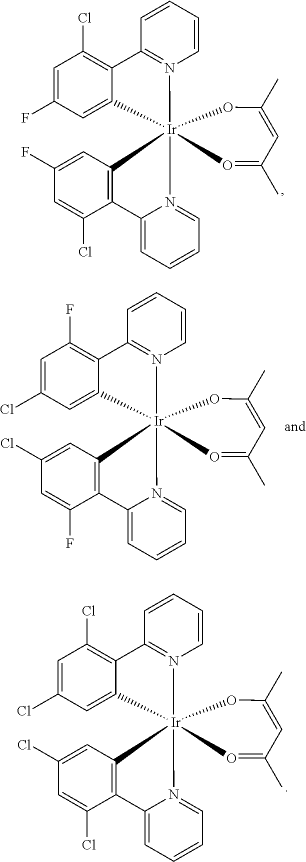

11. The Ir complex according to claim 10, wherein said Ir complex has the following formula:

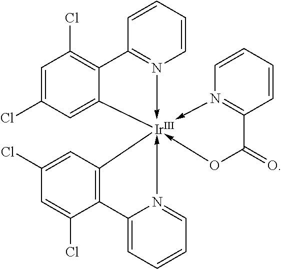

12. The Ir complex according to claim 1, wherein said Ir complex has a quantum yield of greater than 0.6.

13. The Ir complex according to claim 12, wherein said Ir complex has a quantum yield of greater than 0.8.

14. (canceled)

15. A method for preparing the Ir complex according to any of claims 8-14 comprising reacting a dimer comprising two Ir atoms, two phenyl pyridine ligands substituted with at least one Cl atom, and two halogen ligands in the presence of a base compound with a compound from which the ancillary ligand is derived.

16. The method according to claim 15, wherein the compound from which the ancillary ligand is derived is selected from the group consisting of picolinic acid, quinoline carboxylic acid, and their derivatives.

17. The method according to claim 15, wherein the phenyl pyridine ligand is prepared by reacting phenylboronic acid and bromopyridine in the presence of a base compound, with the proviso that at least one of said phenylboronic acid and bromopyridine is substituted with at least one Cl atom.

18. A light emitting material comprising the Ir complex according to claim 1.

19. (canceled)

20. A method for emitting light using an organic light emitting device comprising a host layer, said method comprising:
doping the host layer with the light emitting material according to claim 18; and
operating under conditions efficient for the host layer to function as an emissive layer.

21. An organic light emitting device comprising an emissive layer, wherein said emissive layer comprises the light emitting material according to claim 18.

22. A display device comprising the organic light emitting device according to claim 21.
